(19) United States
(12) Patent Application Publication
(10) Pub. No.: US 2004/0056809 A1
(43) Pub. Date: Mar. 25, 2004

(54) Antenna for a receiver and/or transmitter, especially a roof antenna for motor vehicles

(76) Inventors: Peter Karl Prassmayer, Grosskarolinenfeld (DE); Christian Magg, Garching (DE)

Correspondence Address: NIXON & VANDERHYE, PC, 1100 N GLEBE ROAD, 8TH FLOOR, ARLINGTON, VA, 22201-4714, US

(21) Appl. No.: 10/470,165

(22) PCT Filed: Feb. 20, 2003
(86) PCT No.: PCT/EP03/01751

(30) Foreign Application Priority Data
Feb. 22, 2002 (DE) 102 07 703.7

(51) Int. Cl. H01Q 1/32

(52) U.S. Cl. 343/711; 343/713

(57) ABSTRACT

A receiving and/or transmitting device for motor vehicles has an antenna foot (3), preferably in the form of a housing (5). An electrical connection for an antenna element (17), which is preferably in turn electrically connected to a further antenna element (19) via a lock-out coil (19), is made via an internal connecting line (13). An improved receiving and/or transmitting device is distinguished in that the connecting line (13) is preferably in the form of a bracket (13′), and/or the first antenna element (17) is provided with an electrically conductive extension (25, 25′, 25″).

The invention relates to an antenna for a receiving and/or transmitting device, in particular as a roof antenna for motor vehicles, as claimed in the precharacterizing clause of claim 1.

By way of example, DE 197 39 395 A1 discloses a receiving device, in particular for broadcast radio receivers, for installation in motor vehicles. This has a receiving section with at least one connection, via which further components can be connected. An antenna in the form of a rod can be plugged on above the receiving section.

An antenna for automobiles is also disclosed, for example, in DE 298 21 723 U1. The antenna has an antenna foot which comprises a protective cover in the form of a housing or shroud, and a baseplate which can be mounted on the roof of the automobile. Various electrical devices are accommodated in the internal space between the shroud and the baseplate. Inter alia, a line 12 leads to the actual antenna element devices, which project outward from the foot part. What is referred to as a combination antenna element is used for this purpose, which is provided at its lower end with a threaded projection, in order to make it possible then to screw the threaded antenna element into and out of a threaded bush in the foot part.

In this case, further devices can also be accommodated in the antenna foot, in order in the end to make it possible to receive different frequency bands via one or more radio-frequency lines. Specifically, antennas such as these should be suitable, for example, for various networks in the mobile radio band (for example the D network or E network, as well as for the new UMTS frequency band from about 1 900 MHz to 2 170 MHz). Furthermore, if required, it should also be possible to receive and process GPS signals and/or to receive VHF programs.

The antennas available on the market at the moment have been proven in principle, although different implementation and conversion principles are known.

However, against the background of the last-mentioned antenna of this generic type, there is a problem, in that an antenna such as this with what is referred to as a combination antenna element is now also intended to be suitable for the UMTS Standard in addition to the normal mobile radio band in the DoCoMo band, in the AMPS band, and/or in the GSM 900 band (that is to say in the 810 to 960 MHz band) and/or in the GSM 1 800 and/or in the GSM 1 900 band (that is to say in the 1 710 and 1 990 MHz band). This is because an antenna which is suitable for this overall range implies that, for the higher frequencies which can be transmitted, the antenna elements which are provided for this high frequency range must be designed to be smaller, that is to say shorter, and this also applies to the antenna bracket. However, this would then lead to the antenna having to be modified overall, including the existing antenna element. However, this is contrary to what is referred to as the identical parts concept, on the basis of which, for example, one antenna element type should be used for different purposes.

A two-band antenna has been disclosed, inter alia, in the B1 version of U.S. Pat. No. 6,191,747. This is a multiband antenna using coils for phase shifting in order to form a monopole gain antenna element.

A two-band motor vehicle antenna which forms this generic type and has an antenna foot has been disclosed in WO 0 171 847 A1, in which a connecting line is connected to the antenna element arrangement via an intermediate line piece.

Against the background of the prior art of this generic type, the object of the present invention is therefore to provide an improved multiband antenna arrangement.

According to the invention, the object is achieved on the basis of the features specified in claim 1. Advantageous refinements of the invention are specified in the dependent claims.

It must be regarded as rather surprising that, in principle, an intrinsically highly proven motor vehicle antenna can now be used, for example, for the UMTS Standard as well, that is to say talking in general terms for a considerably higher frequency band, and without any reduction to the physical height or physical size. This is possible because the electrical line which leads to an antenna element for the higher frequency range or a bracket which leads to the antenna element for the higher frequency range is provided with an extension. The extension can be implemented in such a way that the supply lines are lengthened beyond a connecting point or contact point via which the antenna element makes electrical contact with the supply line, and preferably ends freely. If the electrical supply line is formed by an electrically conductive bracket, then the bracket can be lengthened beyond the contact-making point with the first antenna element, with the contact-making point in this case at the same time being used as connecting point or even as attachment point for the antenna element. However, the extension need not necessarily be provided such that it runs continuously over the electrical wire or bracket, but may also be in the form of a line section that is passed back. It is also possible to use an extension which points downward via the connecting point between the electrical supply line or bracket and the electrical antenna element which is provided for the higher frequency range, and which possibly ends shortly before the motor vehicle roof.

Extensions which, for example, are in the form of a disk or of a plate are also suitable, and preferably are provided at the connecting point between the electrical supply line or bracket and the antenna element which is provided for the higher frequency range.

However, normally, not only is one antenna element used, preferably in the form of a bolt, which is provided for the higher frequency range, but a coil followed by a further antenna element is then used in the extension of this antenna element.

In the process, it should be remembered that the entire antenna element arrangement including the antenna bracket acts as an antenna element for the low frequency ranges, that is to say for long waves, medium waves, short waves and the VHF band. For the DoCoMo, the AMPS and the GSM 900 bands (which corresponds to 810 to 960 MHz), the antenna bracket and the lower part of the actual antenna element arrangement, that is to say generally of the antenna element bolt which is provided for this purpose, still act together with one part of the coil that has been mentioned as antenna elements. However, if the frequency is raised further, that is to say for example to the GSM 1 800 and GSM 1 900 bands (which correspond to 1 710 MHz to 1 990 MHz), only the antenna bracket and the lower antenna bolt then still act as antenna elements. However, only the antenna bracket and its extension then still act as antenna elements in the UMTS band (1 900 to 2 170 MHz).

The invention will be explained in the following text for a number of exemplary embodiments with reference to drawings, in which, in detail:

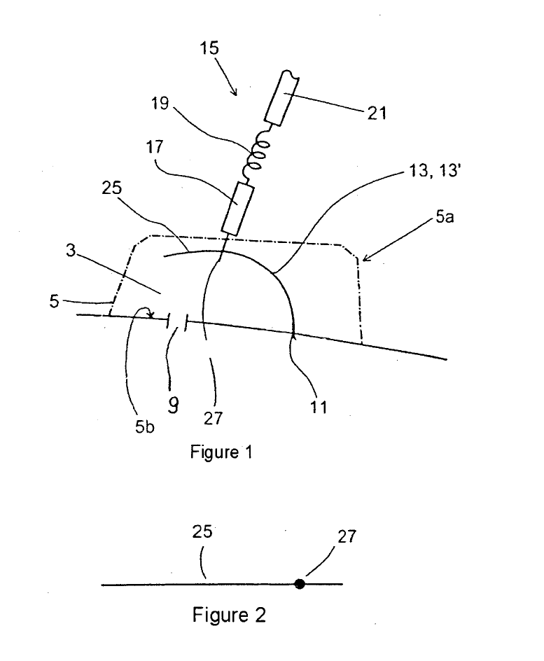

FIG. 1 shows a schematic side view of a first exemplary embodiment according to the invention,

FIG. 2 shows a schematic plan view of the extended bracket in the exemplary embodiment shown in FIG. 1,

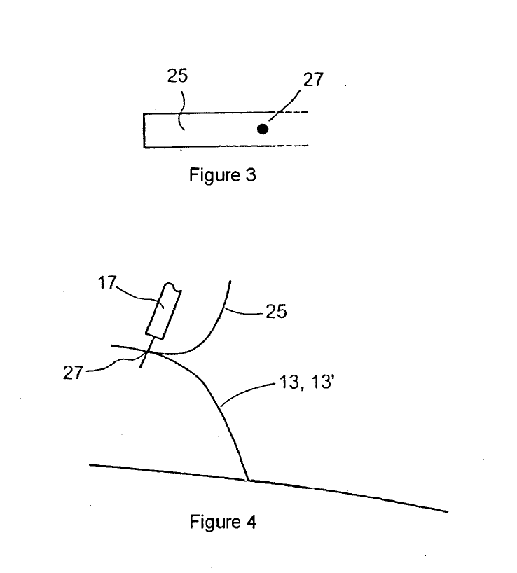

FIG. 3 shows a plan view, corresponding to that in FIG. 2, relating to an extension of the bracket which is designed to be shorter but broader for this purpose;

FIG. 4 shows an exemplary embodiment modified from that shown in FIGS. 1 and 2,

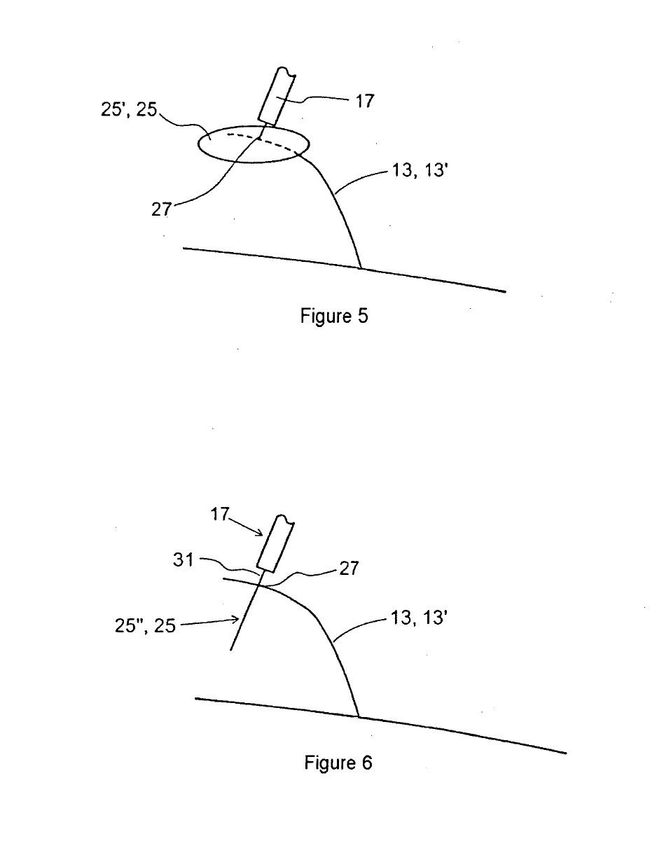

FIG. 5 shows a further modified exemplary embodiment, in the form of a schematic side view, and

FIG. 6 shows a further modified exemplary embodiment.

FIG. 1 shows a schematic side view in the form of a cross section of the contour of a metal bodywork sheet 1 of a motor vehicle, preferably in the roof area adjacent to the rear windshield, on which a corresponding antenna is intended to be mounted.

The transmitting and/or receiving device shown in FIG. 1 for this purpose has an antenna foot 3, which is in the form of a housing 5.

For this purpose, the housing 5 preferably has a protective cover 5a in the form of a shroud, and a bottom plate 5b, which can be attached by suitable measures to the metal bodywork sheet 1, for example using adhesive layers, insulating materials etc.

At least one opening 9 is also generally provided in the metal bodywork sheet 1, via which electrical connecting lines, coaxial cables etc. can be passed to the antenna from the interior of the motor vehicle. For this purpose, the bottom plate of the antenna housing is also fitted in an appropriate manner on the motor vehicle roof, with a threaded dome in the form of a hollow threaded rod normally being used (although this is not shown in any more detail in the drawings but has been known for a long time), is anchored in the bottom plate and projects into the interior of the motor vehicle through the opening 9 in the motor vehicle roof. The lines are then passed inward through the interior of the threaded dome. A central nut can then be screwed to the threaded dome from the interior of the vehicle, in order to anchor the antenna firmly on the motor vehicle roof in this way.

A connecting line 13 leads from an antenna point 11, which is provided in the antenna foot 3, to the actual antenna device 15 which, in the illustrated exemplary embodiment, comprises a first antenna element 17, a lock-out coil 19 which is preferably arranged in an axial extension of the first antenna element 17, and a second antenna element 21 which is once again connected in an axial extension of the lock-out coil 19.

The first antenna element 17 may, for example, comprise a metallically conductive bolt or have a bolt structure. The second antenna element 21 should be as elastic as possible and may, for example, be formed from a glass fiber core around which a corresponding electrical conductive arrangement in the form of a coil is wound. All possible antenna structures are feasible which may be used and are suitable for the respective purpose.

In this case, it should be remembered that the entire antenna element arrangement including the antenna bracket acts as an antenna element for low frequency ranges, that is to say for long waves, medium waves, short waves and the VHF band. For the DoCoMo, the AMPS, and the GSM 900 band (which corresponds to 810 to 960 MHz), the antenna bracket and the lower part of the actual antenna element arrangement, that is to say generally of the antenna element bolt which is provided for this purpose, still act together with a part of the coil which has been mentioned as antenna elements. However, if the frequency is raised further, namely for example in the GSM 1 800 and GSM 1 900 band (which corresponds to 1 710 MHz to 1 990 MHz), only the antenna bracket and the lower antenna bolt still act as antenna elements. In the UMTS band (1 900 to 2 170 MHz), only the antenna bracket and its extension then still act as antenna elements, however.

For high frequency bands, for example in the E network (approximately 1 800 MHz) or in particular for the UMTS Standard (approximately 1 900 to 2 170 MHz) as well, the coil 19 provides blocking, so that only the first antenna element 17 together with the electrical connecting line 13 act as an antenna element for this purpose.

The connecting line 13 which has been mentioned may in this case preferably also be formed from an at least slightly elastic or partially elastic bracket 13′, which is preferably prestressed in the antenna element direction. This means that the antenna bracket has a tendency to rest in a prestressed manner on the lower connecting point of the antenna element (in the interior of the housing) when the antenna element is installed, so that a permanent electrical contact can be provided here without any problems. The antenna element arrangement 15 can in this case normally be connected to the antenna housing 5 by means of a screw connection, so that the antenna, particularly when motor vehicles are passing through a car wash, can be unscrewed in advance without any problems, and can then be screwed on again. The actual antenna element arrangement 15 which can be screwed to the housing is, in the end, held and supported via the housing itself.

In order now to make it possible to use this antenna arrangement for the high frequency band ranges as well, matched to the high frequency band range, not only would the first antenna element, preferably in the form of a bolt 17, but also the electrical connecting line 13 would need to be appropriately reduced in size.

However, since this is contrary to the identical parts concept, on the basis of which, for example, an already existing antenna element arrangement which is also used for other purposes should also be used in the present case, this means that there is a need to look for other solutions.

According to the invention, an extension 25 is provided for this purpose in the exemplary embodiment as shown in FIGS. 1 and 2. In this exemplary embodiment, this extension 25 is in the form of an extension to the connecting line 13 and thus, preferably, an extension to the bracket 13′. It preferably passes beyond the connecting, attachment and/or contact-making point 27 on which the antenna element 17. which is provided for the higher frequency range, that is to say the entire antenna element arrangement is therefore attached and held, possibly via a bridging section on the electrical connecting line 13 or on the bracket 13′.

The length and width of the extension 25 must be designed such that the antenna is correctly tuned overall for the desired higher frequency range. This tuning can be carried out in various ways, as described in the following text.

FIG. 2 shows an extract of the extension 25, in the form of a schematic plan view, in its region which is lengthened beyond the connecting and/or attachment point and/or contact-making point 27. This shows that this extension may in principle be in the form of a wire, even if it is in the form of a rather stiffer, dimensionally stable and possibly elastic bracket 13′.

Apart from an extension according to the exemplary embodiment shown in FIGS. 1 and 2, the extension 25 may also be designed to be shorter if—as can be seen in particular from the plan view in FIG. 3—it is in contrast designed to be broader than in the exemplary embodiment shown in FIGS. 1 and 2.

In the exemplary embodiment shown in FIG. 4, the extension 25 is effectively provided as a separate component with a curved shape, preferably originating from the connecting or attachment point 27, with its free end running increasingly more parallel to the antenna element 17. The length and width of this extension 25 may likewise once again be chosen to be different, in order to carry out the desired tuning for the respectively desired higher frequency band. The exemplary embodiments shown in FIGS. 1 to 4 have the common feature that the extension 25 ends freely, from the electrical point of view.

In the exemplary embodiment shown in FIG. 5, the extension 25 is shown in a virtually “degenerate” form. Specifically, the extension 25 is now in the form of a disk or of a plate 25′. This disk or this plate 25′ can thus now be continued not only in one direction away from the connecting line 13, that is to say from the bracket 13′, but may effectively be in the form of a flat component in the circumferential direction. Finally, FIG. 6 also shows that the extension 25 may be regarded and/or designed effectively as an extension 25 with respect to the first antenna element 17, as well. Specifically, according to this exemplary embodiment, the extension 25 is in the form of an axial extension 25″ to the first antenna element 17, which is preferably in the form of a bolt, effectively as an extension to a short electrically conductive bridging piece, which provides an electrical connection from the connecting point 27 of the connecting line 13 to the first antenna element 17.

Patent claims:

1. An antenna for a receiving and/or transmitting device for motor vehicles, having the following features:
having an antenna foot (3),
having a connecting line (13), which is provided in the antenna foot (3), for electrical connection of an antenna element arrangement (17, 21),
the antenna element arrangement (17, 21) has at least one first antenna element (17), and
in addition to the antenna element arrangement (17), the antenna element arrangement (17, 21) preferably has a further antenna element arrangement (21) which is connected to the antenna element arrangement (17) via a lock-out coil (19), with the lock-out coil (19) opening and the first and second antenna element arrangement (17, 19) acting as a common antenna element arrangement at low frequencies, while in contrast the lock-out coil (19) closes at higher frequencies,
characterized by the following further features
the connecting line (13) for the antenna element arrangement (17, 21) and/or the antenna element arrangement (17) itself is provided with an electrically conductive extension (25; 25′, 25″),
the extension (25; 25′, 25″) is provided in the region of the antenna foot (3) or in the region of a housing which is part of the antenna foot (3), and
the extension (25; 25′, 25″) is in the form of a branch with respect to the electrical line arrangement which comprises the connecting line (13) and the antenna element arrangement (17).

2. The antenna as claimed in claim 1, characterized in that the extension (25, 25′, 25″) is accommodated in the antenna foot (3), preferably in an antenna foot housing (5).

3. The antenna as claimed in claim 1 or 2, characterized in that the extension (25, 25′) is in the form of a direct branching extension of the electrical connecting line (13), with the electrical connecting line (13) being lengthened beyond a connecting, attachment and/or contact-making point (27), and the connecting, attachment and/or contact-making point (27) representing an electrical connection for a first antenna element arrangement (17) or for a bridging piece (31) which leads to the first antenna element arrangement (17).

4. The antenna as claimed in claim 1 or 2, characterized in that the extension (25) is in the form of a separate component, and/or is in the form of an extension to the connecting line (13), preferably in the form of a bracket (13′), forming a kink point.

5. The antenna as claimed in one of claims 1 to 4, characterized in that, with respect to the first antenna element arrangement (17), the extension (25, 25′) is located on the same side with respect to this as the connecting line (13).

6. The antenna as claimed in claim 4, characterized in that the extension (25) is in the form of an arc, and its free end ends increasingly laterally offset approximately parallel to the axial longitudinal extent of the first antenna element arrangement (17).

7. The antenna as claimed in one of claims 1 to 5, characterized in that the extension (25, 25′) and the electrical supply line (13) are arranged opposite the antenna element arrangement (17).

8. The antenna as claimed in one of claims 1 to 4, characterized in that the extension (25) is in the form of a flat element (25″), preferably in the form of a disk or plate.

9. The antenna as claimed in claim 1 or 2, characterized in that the extension (25) is in the form of the extension (25″) with respect to the first antenna element arrangement (17), which is lengthened beyond the connecting, the attachment and/or the contact-making point (27) in the direction of the bottom plate (5b) of the antenna foot (3).

10. The antenna as claimed in one of claims 1 to 9, characterized in that the extension (25) is in the form of a wire, rod or plate.

11. The antenna as claimed in one of claims 1 to 10, characterized in that the extension (25) is designed to. be shorter and broader than an extension in the form of a wire, rod or plate.

12. The antenna as claimed in one of claims 1 to 11, characterized in that the connecting line (13) is formed like a bracket (13′).

13. The antenna as claimed in claim 12, characterized in that the extension (25; 25′, 25″) together with the connecting line (13) is in the form of a common bracket (13′).
